(19) United States
(12) Patent Application Publication
(10) Pub. No.: US 2015/0035702 A1
(43) Pub. Date: Feb. 5, 2015

(54) GPS JAMMING SIGNAL RECEIVER AND GPS JAMMING SIGNAL RECEIVING METHOD

(71) Applicant: Electronics and Telecommunications Research Institute, Daejeon (KR)

(72) Inventors: In One JOO, Daejeon (KR); Jeom Hun LEE, Daejeon (KR); Sang Uk LEE, Daejeon (KR); Jae Hoon KIM, Daejeon (KR)

(21) Appl. No.: 14/301,464

(22) Filed: Jun. 11, 2014

(30) Foreign Application Priority Data
Aug. 1, 2013 (KR) 10-2013-0091684

(51) Int. Cl. G01S 19/21

(52) U.S. Cl. CPC G01S 19/21
USPC 342/357.59

(57) ABSTRACT

A global positioning system (GPS) jamming signal receiver and a GPS jamming signal receiving method are provided. The GPS jamming signal receiver may include a sample data generator to generate a sample data signal with respect to a signal received through an GPS antenna; a jamming signal determiner to determine a jamming state of a GPS jamming signal using the sample data signal and a navigation processing result value of the sample data; and a transmission direction angle calculator to determine a phase difference value of the GPS jamming signal according to the determination result and to calculate a transmission direction angle of the GPS jamming signal.

### CROSS-REFERENCE TO RELATED APPLICATION

This application claims the benefit of Korean Patent Application No. 10-2013-0091684, filed on Aug. 1, 2013, in the Korean Intellectual Property Office, the disclosure of which is incorporated herein by reference.

### BACKGROUND

1. Field of the Invention

The present invention relates to a global positioning system (GPS) jamming signal receiver and a GPS jamming signal receiving method, and more particularly, to a GPS jamming signal receiver and a GPS jamming signal receiving method that detect a GPS jamming signal from a smart device and provide a GPS anti-jamming function based on the GPS jamming signal.

2. Description of the Related Art

A global positioning system (GPS) is an only navigation satellite system being perfectly operated. The GPS is applied to various fields including vehicle navigation, measurement, map producing, geodetic survey, weapon guidance, and the like. Recently, a GPS receiver is widely spread and built in smart devices such as a smart phone and a smart pad, thereby being easily utilized in daily life. Furthermore, the GPS receiver is used even in a government backbone network including a mobile communication network, a power grid, a financial network, and the like, while playing an important role in various fields.

The GPS may easily calculate accurate location information by using a receiver. However, since a GPS satellite is at approximately twenty thousand kilometers away in the upper air, strength of received signals is insufficient and therefore the received signals are subject to jamming That is, presuming that a GPS signal is a level of starlight seen deep in a mountain with clear air, a jamming signal may be likened to a searchlight emitted nearby. When a strong jamming signal is generated in a same frequency band, the GPS signal should be disturbed. As an actual example related to the GPS signal disturbance, there is an event that an unmanned drone RQ-170 of U.S.A. flying over Iran forcibly landed due to jamming by Iran in December 2011. Such signal jamming has occurred not only overseas but also internally. Allegedly, airplanes and ships navigating around the Incheon international airport and the West sea were affected by GPS jamming in August 2010, March 2011, and April 2012. Thus, while the GPS is playing important parts in various fields, such frequent occurrence of GPS jamming all around the world is a serious matter.

Accordingly, to prevent and minimize national damages by GPS jamming, an anti jamming technology that monitors GPS jamming, detects a direction of a GPS jamming signal, and overcomes GPS jamming is being developed.

However, general anti jamming devices have a large volume and a complicated system, that is, lack portability. Therefore, most of anti jamming devices are used as a fixed type. Although mobile anti jamming devices are introduced, they are used in a state of being mounted on a vehicle. Therefore, GPS jamming detection and direction detection using even the mobile anti jamming devices are very limited for a user.

### SUMMARY

An aspect of the present invention provides a global positioning system (GPS) jamming signal receiver and a GPS jamming signal receiving method which enable a user to normally receive GPS jamming signals and perform positioning anytime and anywhere, by providing an anti jamming function that monitors GPS jamming, detects a direction of the GPS jamming signals according to the monitor result, and offsets the GPS jamming signals, in a smart device such as a smart phone or smart pad having high portability.

Another aspect of the present invention provides a GPS jamming signal receiver and a GPS jamming signal receiving method enabling direction recognition with respect to GPS jamming signals and providing an anti jamming function through a minimal hardware configuration and simplified system, by detecting the GPS jamming signal and calculating a spectrum based on software, for example using an application, without additional hardware in a smart device.

According to an aspect of the present invention, there is provided a GPS jamming signal receiver including a sample data generator to generate a sample data signal with respect to a signal received through an GPS antenna, a jamming signal determiner to determine a jamming state of a GPS jamming signal using the sample data signal and a navigation processing result value of the sample data, and a transmission direction angle calculator to determine a phase difference value of the GPS jamming signal according to the determination result and to calculate a transmission direction angle of the GPS jamming signal.

According to another aspect of the present invention, there is provided a GPS jamming signal receiving method including generating a sample data signal with respect to a signal received through an GPS antenna, determining a jamming state of a GPS jamming signal using the sample data signal and a navigation processing result value of the sample data, and determining a phase difference value of the GPS jamming signal according to the determination result and calculating a transmission direction angle of the GPS jamming signal.

### EFFECT

According to embodiments of the present invention, a global positioning system (GPS) jamming signal receiver and a GPS jamming signal receiving method enable a user to normally receive GPS jamming signals and perform positioning anytime and anywhere, by providing an anti jamming function that monitors GPS jamming, detects a direction of the GPS jamming signals according to the monitor result, and offsets the GPS jamming signals, in a smart device such as a smart phone or smart pad having high portability.

Additionally, according to embodiments of the present invention, a GPS jamming signal receiver and a GPS jamming signal receiving method enable direction recognition with respect to GPS jamming signals and provide an anti jamming function through a minimal hardware configuration and simplified system, by detecting the GPS jamming signal and calculating a spectrum based on software, for example using an application, without additional hardware in a smart device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation concept of a global positioning system (GPS) jamming signal receiver according to an embodiment of the present invention;

FIG. 2 is a diagram illustrating a GPS jamming signal receiver according to an embodiment of the present invention;

FIG. 3 is a diagram illustrating a detailed configuration of a GPS jamming signal receiver according to an embodiment of the present invention;

FIG. 4 is a diagram illustrating a wave phase interferometry according to an embodiment of the present invention; and

FIG. 5 is a diagram illustrating a GPS jamming signal receiving method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

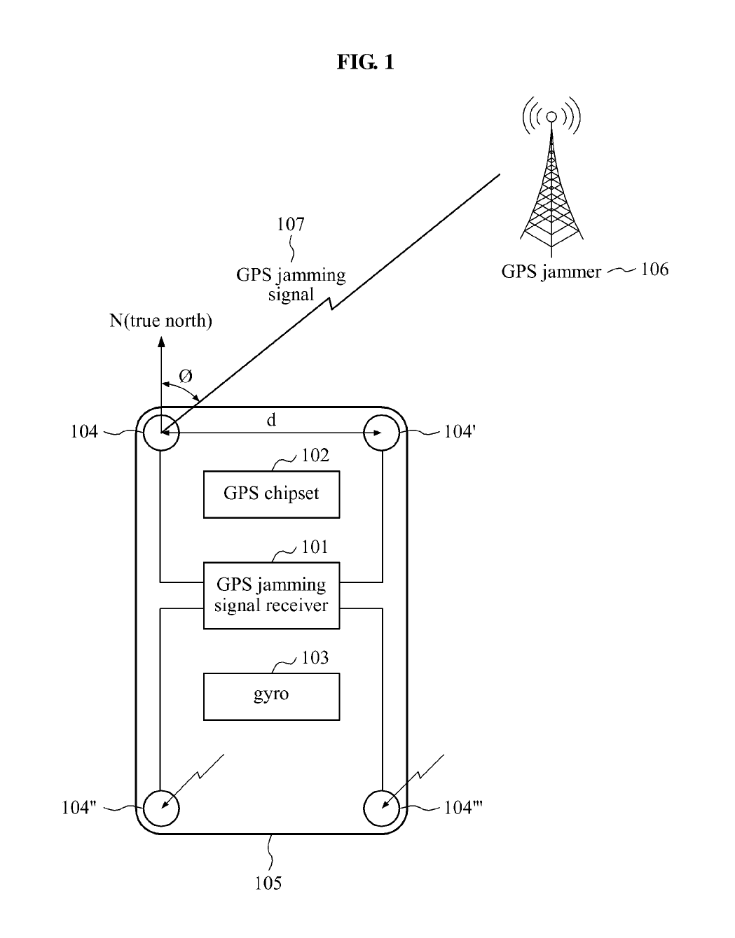

FIG. 1 is a diagram illustrating an operation concept of a global positioning system (GPS) jamming signal receiver 101 according to an embodiment of the present invention.

Referring to FIG. 1, a GPS jamming signal receiver 101 may be included in a smart device 105, and the smart device 105 may further include GPS antennas 104, 104′, 104″, and 104′″, a GPS chipset 102, and a gyro 103. The GPS jamming signal receiver 101 may detect a GPS jamming signal 107 by operating in association with the GPS chipset 102 and the gyro 103, and calculate a transmission direction of the GPS jamming signal 107 corresponding to the detected GPS jamming signal. The smart device 105 may include a smart phone, a smart pad, and the like but is not limited thereto.

The GPS jamming signal receiver 101 may receive a signal from the GPS antennas 104, 104′, 104″, and 104′″. The signal may be the GPS jamming signal 107. The GPS jamming signal 107 may be transmitted from a GPS jammer 106. The GPS jammer 106 may include all types of transmitter, transmitting tower, and the like transmitting the GPS jamming signal 107.

The GPS antennas 104, 104′, 104″, and 104′″ may be arranged at uniform intervals from any one reference GPS antenna, for example the GPS antenna 104. That is, the GPS antennas 104, 104′, 104″, and 104′″ may be arranged according to predetermined distances. For example, the reference GPS antenna 104 may be disposed at any one reference corner among corners of the smart device while the remaining GPS antennas 104′, 104″, and 104′″ are disposed at the predetermined positions and distances from the GPS antenna 104.

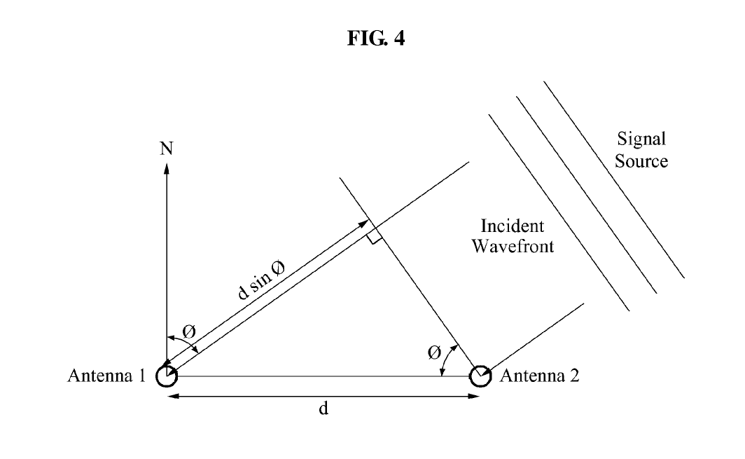

The reference GPS antenna 104 may function as a reference for calculating position difference values among the GPS antennas 104′, 104″, and 104′″ different from one another. For example, when the reference GPS antenna 104 and the GPS antenna 104′ are separated by a distance d1, the reference GPS antenna 104 may receive a delayed signal of the GPS jamming signal 107 from the GPS jammer 106, delayed as much as a phase difference ΔΨ from the GPS antenna 104′. Here, a wavelength λ of a pseudo satellite signal may be approximately 19 cm in case of a GPS L1 signal. Hereinafter, a method of calculating the GPS position difference value will be described in detail with reference to FIG. 4.

The GPS jamming signal receiver 101 may generate GPS sample data signals using signals received through the GPS antennas 104, 104′, 104″, and 104′″. In addition, the GPS jamming signal receiver 101 may calculate a navigation processing result value using at least one sample data signal among the generated sample data signals. Here, the GPS jamming signal receiver 101 may calculate the navigation processing result value using the GPS chipset 102. The navigation processing result value includes a navigation message, measured data, a positioning result, and the like.

The GPS jamming signal receiver 101 may determine a jamming state of the GPS jamming signal using the sample data signal and the navigation processing result value of the sample data signal. In addition, the GPS jamming signal receiver 101 may detect a phase difference value of the GPS jamming signal depending on the determination result with respect to the GPS jamming signal, and calculate a transmission direction angle of the GPS jamming signal.

According to an embodiment, the GPS jamming signal receiver 101 calculates the transmission direction angle of the GPS jamming signal and therefore the smart device 105 including the GPS jamming signal receive 101 may be oriented according to the transmission direction angle. As a result, an anti jamming effect that offsets the GPS jamming signal may be provided.

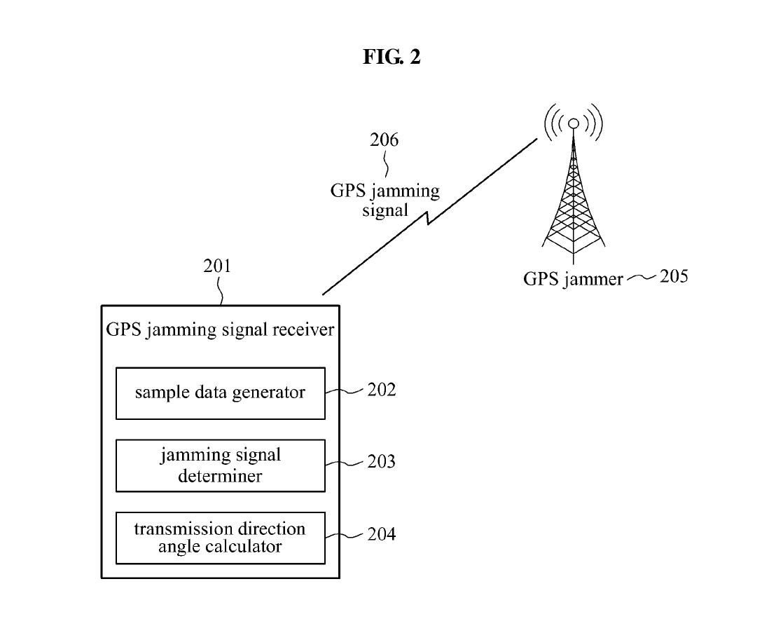

FIG. 2 is a diagram illustrating a GPS jamming signal receiver 201 according to an embodiment of the present invention.

Referring to FIG. 2, the GPS jamming signal receiver 201 may include a sample data generator 202, a jamming signal determiner 203, and a transmission direction angle calculator 204.

The sample data generator 202 may generate a sample data signal with respect to a signal received through a GPS antenna. To be specific, the sample data generator 202 may receive a signal of a GPS frequency band through the GPS antenna and convert the received signal into a medium frequency signal through down conversion. The sample data generator 202 may generate the sample data signal by digitizing the down converted medium frequency signal. Here, the sample data generator 202 may generate a plurality of sample data signals corresponding to a number of GPS antennas associated with the GPS jamming signal receiver. For example, the sample data generator 202 may convert the received signal into four medium frequency signals corresponding to signals received from four GPS antennas, and generate four sample data signals according to the four medium frequency signals.

The jamming signal determiner 203 may determine a jamming state of the GPS jamming signal using the sample data signal and the navigation processing result value of the sample data signal. That is, the jamming signal determiner 203 may calculate the navigation processing result value using at least one sample data signal among the generated sample data signals. Here, the jamming signal determiner 203 may use a GPS chipset calculating the navigation processing result value.

In addition, the jamming signal determiner 203 may calculate a spectrum value of the GPS frequency band using at least one sample data signal among the generated sample data signals. Here, the jamming signal determiner 203 may process the sample data signals using a fast Fourier transform (FFT) method based on software, and calculate the spectrum value of the GPS frequency band. Accordingly, the jamming signal determiner 203 may determine whether the signal received through the GPS antenna is the GPS jamming signal through the navigation processing result value or the spectrum value.

The transmission direction angle calculator 204 may detect the phase difference value of the GPS jamming signal according to the determination result with respect to the jamming state of the GPS jamming signal, and calculate the transmission direction angle of the GPS jamming signal. That is, when the GPS jamming signal is determined by the jamming signal determiner 203, the transmission direction calculator 204 may calculate the phase difference value between the sample data signals using at least two of the sample data signals. Additionally, the transmission direction angle calculator 204 may detect the transmission direction angle of the GPS jamming signal using the phase difference value. Here, the transmission direction angle calculator 204 may calculate the transmission direction angle after determining true north using a gyro sensor that measures an angular velocity.

A user may control a smart device including the GPS jamming signal receiver 201 to be oriented according to the calculated transmission direction angle. According to the position control of the smart device, the smart device may be oriented in a same direction as the GPS jamming signal received through the GPS antenna. Therefore, the transmission direction angle may become zero. That is, the GPS jamming signal receiver may provide the anti jamming effect by calculating the transmission direction angel of the GPS jamming signal received through the GPS antenna and changing the orientation of the smart device corresponding to the calculated transmission direction angle so that the transmission direction angle of receiving the GPS jamming signal becomes zero. By generating the anti jamming effect with respect to the GPS jamming signal, the GPS jamming signal receiver may receive normal GPS signals excluding the GPS jamming signal and calculate normal positioning values with respect to the received GPS signals.

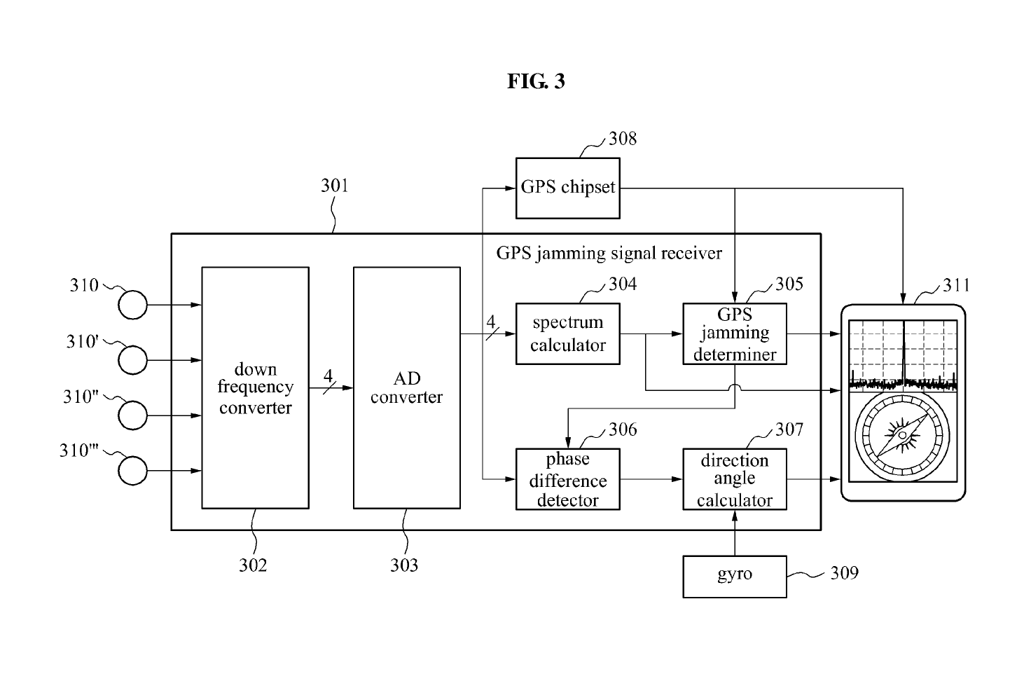

FIG. 3 is a diagram illustrating a detailed configuration of a GPS jamming signal receiver 301 according to an embodiment of the present invention.

Referring to FIG. 3, the GPS jamming signal receiver 301 includes a down frequency converter 302, an analog-digital (AD) converter 303, a spectrum calculator 304, a GPS jamming determiner 305, a phase difference detector 306, and a direction angle calculator 307.

The down frequency converter 302 may receive signals of a GPS frequency band through GPS antennas 310, 310′, 310″, and 310′″. Here, the signals may include GPS jamming signals transmitted from a GPS jammer. The down frequency converter 302 may down convert the received signals into analog medium frequency signals. The down frequency converter 302 may convert the signals into a plurality of medium frequency signals corresponding to a number of the received signals received from the GPS antennas 310, 310′, 310″, and 310′″. For example, the down frequency converter 302 may convert four signals received from the GPS antennas 310, 310′, 310″, and 310′″ into four medium frequency signals.

The AD converter 303 may convert the analog medium frequency signals converted by the down frequency converter 302 into digital sample data signals. Here, the AD converter 303 may generate the sample data signals corresponding to the medium frequency signals in number. For example, the AD converter 303 may convert four medium frequency signals into four sample data signals, respectively.

The down frequency converter 302 and the AD converter 303 may match the sample data generator 202 illustrated in FIG. 2.

A GPS chipset 308 may calculate a navigation processing result value using at least one of the sample data signals converted by the AD converter 303. The navigation processing result value may include a navigation message, measured data, a positioning result, and the like. The GPS chipset 308 may display the navigation processing result value on a screen 311 of a smart device.

The spectrum calculator 304 may calculate a spectrum value of a GPS frequency band by performing FFT with respect to at least one of the sample data signals converted by the AD converter 303. Additionally, the spectrum calculator 304 may display the spectrum value on the display 311 of the smart device. When receiving the GPS jamming signal, the spectrum calculator 304 may determine a jamming state of the GPS jamming signal using the spectrum. Here, the jamming state of the GPS jamming signal may refer to whether a GPS signal is jammed by the GPS jamming signal.

The GPS jamming determiner 305 may determine the jamming state of the GPS jamming signal using the navigation processing result value calculated by the GPS chipset 308, when receiving the GPS jamming signal.

Here, the spectrum calculator 304 and the GPS jamming determiner 305 may match the jamming signal determiner 203 illustrated in FIG. 2.

The phase difference detector 306 may detect a phase difference value between sample data signals based on the sample data signals depending on the jamming state. That is, when it is determined to be the GPS jamming signal, the phase difference detector 306 may detect the phase difference value between the sample data signals using at least two sample data signals among the generated sample data signals.

When the GPS jamming signal is determined, the direction angle calculator 307 may calculate a transmission direction angle of the GPS jamming signal on the basis of true north determined by a gyro sensor 309. Here, the direction angle calculator 307 may determine the transmission direction angle by a wave phase interferemetry that uses the phase difference value detected by the phase difference detector 306. The wave phase interferemetry will be described in detail with reference to FIG. 4. The direction angle calculator 307 may display the calculated transmission direction angle on the display 311 of the smart device.

The spectrum calculator 304, the GPS jamming determiner 305, the phase difference detector 306, and the direction angle calculator 307 according to the embodiment may be implemented based on software such as an application used in the smart device. The GPS antennas 310, 310′, 310″, and 310′″, the down frequency converter 302, the AD converter 303, the GPS chipset 308, and the gyro sensor 309 according to the embodiment may be preinstalled in the smart device. However, the GPS antennas 310, 310′, 310″, and 310′″, the down frequency converter 302, and the AD converter 303 are additionally adopted for recognition of a direction of GPS jamming and for the anti jamming function. Depending on circumstances, only a single number of the GPS antenna, the down frequency converter 302, and the AD converter 303 may be used for minimal configuration.

Accordingly, hardware complexity of the GPS jamming signal receiver 301 may not be highly increased. When only detection of the GPS jamming signal and calculation of the spectrum are demanded by users, the foregoing functions may be implemented in the conventional smart phone based on the software such as an application without an additional hardware structure.

FIG. 4 is a diagram illustrating a wave phase interferemetry according to an embodiment of the present invention.

Referring to FIG. 4, a GPS antenna 1 401 and a GPS antenna 2 402 may receive signals having a wavelength λ transmitted from a signal source. The GPS antenna 1 401 and the GPS antenna 2 402 may be separated by a distance d. The GPS antenna 1 401 may receive a signal delayed by as much as a phase difference ΔΨ from a signal received by the GPS antenna 2 402. When an incidence angle of a signal transmitted from an imaginary line orthogonal to a baseline of the GPS antenna 1 401 and the GPS antenna 2 402 is φ, relationships between a wavelength and a phase in the GPS antenna 2 402 may be expressed by Equation 1.

λ:d sin φ=2π:ΔΨ [Equation 1]

The phase difference ΔΨ between signals received by GPS antenna 1 401 and the

GPS antenna 2 402 may be expressed by [Equation 2].

$$ΔΨ = \frac{d sin φ \cdot 2 π}{λ} = ( 2 π d \text{/} λ ) sin φ \qquad [ Equation 2 ]$$

The transmission direction angle of the signal transmitted from the signal source and the incidence angle φ, may be expressed by [Equation 3].

φ=sin⁻¹(ΔΨλ/2πd) [Equation 3]

That is, when the phase difference between the signals received from the GPS antenna 1 401 and the GPS antenna 2 402 ΔΨ is known, a direction angle of the signal source and the incidence angle φ, may be calculated through the transmission direction angle. When a plurality of transmission direction angles and incidence angles φ, are calculated by installing at least two antennas, the transmission direction angle may correspond to an overlap position of the plurality of direction angles. The overlap position may calculate the direction angles by the position of the signal source.

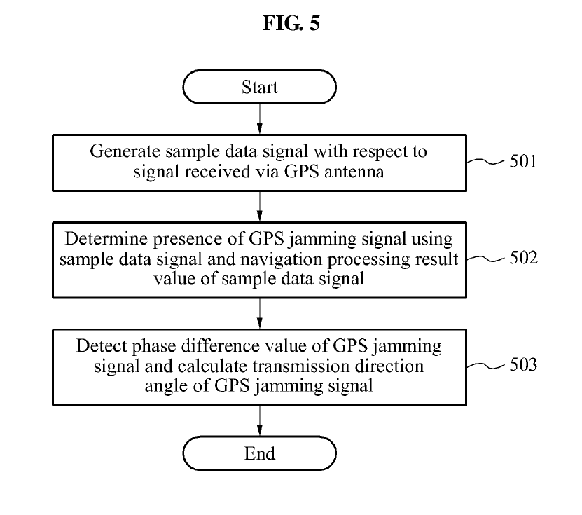

FIG. 5 is a diagram illustrating a GPS jamming signal receiving method according to an embodiment of the present invention.

In operation 501, a GPS jamming signal receiver may generate a sample data signal with respect to a signal received through a GPS antenna. That is, the GPS jamming signal receiver may receive a signal of a GPS frequency band through the GPS antenna and convert the received signal into an analog medium frequency signal. The GPS jamming signal receiver may generate the sample data signal by converting the analog medium frequency signal into a digital sample data signal.

In operation 502, the GPS jamming signal receiver may determine a jamming state of the GPS jamming signal using the sample data signal and a navigation processing result value of the sample data signal. In detail, the GPS jamming signal receiver may determine the jamming state using the navigation processing result value of the sample data signal calculated by a GPS chipset. The GPS chipset may display the navigation processing result value on a screen of a smart device.

The GPS jamming signal receiver may perform FFT with respect to the sample data signal, thereby calculating a spectrum value of a GPS frequency band. The GPS jamming signal receiver may display the spectrum value on the screen of the smart device. The jamming state of the GPS jamming signal may determine whether the GPS jamming signal received through the GPS antenna jams a normal GPS signal.

In operation 503, the GPS jamming signal receiver may detect a phase difference of the GPS jamming signal according to the determination result with respect to the jamming state, and may calculate a transmission direction angle of the GPS jamming signal. Here, the GPS jamming signal receiver may detect the phase difference between sample data signals using at least two sample data signals. The GPS jamming signal receiver may detect a phase difference among a plurality of different GPS antennas with respect to a reference GPS antenna. For example, a process of detecting the phase difference among the GPS antennas of the GPS jamming signal receiver with respect to the GPS antenna of FIG. 1 is described. The GPS jamming signal receiver may detect the phase difference between the reference GPS antenna 104 and the different GPS antennas 104′, 104″, and 104′″.

The GPS jamming signal receiver may determine true north and calculate the transmission direction angle of the GPS jamming signal using the phase difference. Here, when a plurality of transmission direction angles are calculated, the GPS jamming signal receiver may calculate an overlap position of the plurality of transmission direction angles. The overlap position may be a position in which a GPS jammer, that is, a signal source is generated. Therefore, the overlap position may be a more accurate transmission direction angle of the GPS jamming signal.

A user may position the normal GPS jamming signal by offsetting the GPS jamming signal by changing orientation of the smart device corresponding to the calculated transmission direction angle.

Moreover, a smart device mounting the GPS jamming signal receiver may provide the anti jamming function that enables the user to easily detect the GPS jamming and detect a direction of the GPS jamming signal anytime and anywhere.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A global positioning system (GPS) jamming signal receiver comprising:
a sample data generator to generate a sample data signal with respect to a signal received through an GPS antenna;
a jamming signal determiner to determine a jamming state of a GPS jamming signal using the sample data signal and a navigation processing result value of the sample data; and
a transmission direction angle calculator to determine a phase difference value of the GPS jamming signal according to the determination result and to calculate a transmission direction angle of the GPS jamming signal.

2. The GPS jamming signal receiver of claim 1, wherein the sample data generator generates the sample data signal by converting the signal received through the GPS antenna into a medium frequency signal through down frequency conversion and by digitizing the medium frequency signal into the sample data signal.

3. The GPS jamming signal receiver of claim 1, wherein the GPS antenna comprises a plurality of different GPS antennas arranged at distances from a reference GPS antenna which is one of the GPS antennas.

4. The GPS jamming signal receiver of claim 1, wherein the navigation processing result value comprises a navigation message, measured data, and a positioning result.

5. The GPS jamming signal receiver of claim 1, wherein the jamming signal determiner calculates the navigation processing result value through a GPS chipset that calculates the navigation processing result value using at least one of the sample data signal.

6. The GPS jamming signal receiver of claim 1, wherein the jamming signal determiner calculates a spectrum value of a GPS frequency band using at least one of the sample data signal and determines the jamming state of the GPS jamming signal using the spectrum value of the GPS frequency band.

7. The GPS jamming signal receiver of claim 1, wherein the transmission direction angle calculator calculates the transmission direction angle of the GPS jamming signal using a wave phase interferemetry method.

8. The GPS jamming signal receiver of claim 1, wherein the transmission direction angle calculator detects a phase difference between sample data signals using at least two of the sample data signal when the jamming state of the GPS jamming signal is determined.

9. The GPS jamming signal receiver of claim 1, wherein the transmission direction angle calculator determines true north for direction calculation and calculates a transmission direction angle of the GPS jamming signal using the phase difference value.

10. A global positioning system (GPS) jamming signal receiving method comprising:
generating a sample data signal with respect to a signal received through an GPS antenna;
determining a jamming state of a GPS jamming signal using the sample data signal and a navigation processing result value of the sample data; and
determining a phase difference value of the GPS jamming signal according to the determination result and calculating a transmission direction angle of the GPS jamming signal.

11. The GPS jamming signal receiving method of claim 10, wherein the generating comprises:
generating the sample data signal by converting the signal received through the GPS antenna into a medium frequency signal through down frequency conversion and by digitizing the medium frequency signal into the sample data signal.

12. The GPS jamming signal receiving method of claim 10, wherein the GPS antenna comprises a plurality of different GPS antennas arranged at distances from a reference GPS antenna which is one of the GPS antennas.

13. The GPS jamming signal receiving method of claim 10, wherein the navigation processing result value comprises a navigation message, measured data, and a positioning result.

14. The GPS jamming signal receiving method of claim 10, wherein the determining comprises calculating the navigation processing result value through a GPS chipset that calculates the navigation processing result value using at least one of the sample data signal.

15. The GPS jamming signal receiving method of claim 10, wherein the determining comprises:
calculates a spectrum value of a GPS frequency band using at least one of the sample data signal and determines the jamming state of the GPS jamming signal using the spectrum value of the GPS frequency band.

16. The GPS jamming signal receiving method of claim 10, wherein the calculating comprises calculating the transmission direction angle of the GPS jamming signal using a wave phase interferemetry method.

17. The GPS jamming signal receiving method of claim 10, wherein the calculating comprises detecting a phase difference between sample data signals using at least two of the sample data signal when the jamming state of the GPS jamming signal is to determined.

18. The GPS jamming signal receiving method of claim 10, wherein the calculating comprises determining true north for direction calculation and calculates a transmission direction angle of the GPS jamming signal using the phase difference value.
